(19) United States
(12) Patent Application Publication
(10) Pub. No.: US 2008/0028301 A1
(43) Pub. Date: Jan. 31, 2008

(54) Document markup processing system and method

(75) Inventors: Douglas Look, Ithaca, NY (US); Greg Remmert, Walnut Creek, CA (US); Carolyn Kreisel, Trumansburg, NY (US); Mark Reichert, Ithaca, NY (US)

Correspondence Address: PATTERSON & SHERIDAN, L.L.P., 3040 POST OAK BOULEVARD, SUITE 1500, HOUSTON, TX, 77056, US

(73) Assignee: Autodesk, Inc.

(21) Appl. No.: 11/255,685

(22) Filed: Oct. 20, 2005

Related U.S. Application Data
(60) Provisional application No. 60/673,976, filed on Apr. 22, 2005.

(51) Int. Cl. G06F 17/00

(52) U.S. Cl. 715/255; 715/230; 715/229; 715/234; 715/239

(57) ABSTRACT

A document that has been created with a document authoring software is published for viewing using a document viewing software. The document viewing software provides tools for viewing and annotating the published document and saving the published document with the annotations. When the published document with the annotations is opened using the document authoring software, the original document created with the document authoring software is also opened so that modifications can be made to the original document based on the annotations.

### RELATED APPLICATION

This application claims the benefit of Provisional Patent Application No. 60/673,976, filed Apr. 22, 2005, entitled “Document Markup Processing System and Method.”

### BACKGROUND OF THE INVENTION

1. Field of the Invention

The present invention relates generally to document management and, more particularly, to systems and methods for processing document markups.

2. Description of the Related Art

In the review process of documents, e.g., CAD drawings, the documents are distributed to one or more reviewers for annotation and markup. The annotations and markups made by the reviewers include comments and often indicate changes to be made to the original document. To provide their comments and propose changes to the original document, the reviewers need access to the software that was used to create the original document.

For word processing software, this may not be a problem because such software is ubiquitous. For more complex types of software, e.g., CAD software, the cost of providing each reviewer access to such software may be prohibitive. Even if cost is not an issue, lack of training in the use of such software may limit the ability of the reviewers to provide meaningful comments.

### SUMMARY OF THE INVENTION

The present invention facilitates the process of reviewing by providing reviewers with a software application that is different from the software application that is used to create the original document. According to embodiments of the present invention, the software application provided to the reviewers is, for the most part, easier to use and/or cheaper to procure, than the software application that is used to create the original document, and has tools for viewing and annotating the original document, so that reviewers can provide their comments and propose changes to the original document.

As one example, the original document may be created from AutoCAD®, which may be too expensive or difficult to use for many of the reviewers. Therefore, Autodesk's DWF Composer, which is a much simpler and lower cost software application than AutoCAD®, is provided for the reviewers. The drawings from AutoCAD® are published and distributed in DWF (Drawing Web Format), an electronic publishing format, and viewed and annotated in that format by the reviewers using DWF Composer.

Therefore, according to various embodiments of the invention, a document that has been created with a document authoring software (e.g., AutoCAD®) is published for viewing using a document viewing software (e.g., Autodesk's DWF Composer). The document viewing software provides tools for viewing and annotating the published document and saving the published document with the annotations. When the published document with the annotations is opened using the document authoring software, the original document created with the document authoring software is also opened so that modifications can be made to the original document while reviewing the annotations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating the method of managing markups relating to a document in accordance with an embodiment of the invention.

FIG. 2 is a sample interface of a document authoring software showing a portion of a drawing file created with the document authoring software.

FIG. 3 is a sample interface of a document viewing software showing a portion of a DWF file that has been published by the document authoring software.

FIG. 4 is a sample interface of a document viewing software showing a portion of a DWF file and a hyperlink to another portion of the DWF file.

FIG. 5 is a sample interface of a document viewing software showing a portion of a DWF file and various measurement tools for measuring the distance and area of a space.

FIG. 6 is a sample interface of a document viewing software showing a portion of a DWF file and properties of the space measured with the measurement tools shown in FIG. 5.

FIG. 7 is a sample interface of a document viewing software showing a portion of a DWF file and various markup tools used for annotations.

FIG. 8 is a sample interface of a document authoring software showing a portion of a DWF file with annotations superimposed on a corresponding portion of the original drawing file.

FIG. 9 is a sample interface of a document viewing software showing a portion of a DWF file that has been republished by the document authoring software.

### DETAILED DESCRIPTION

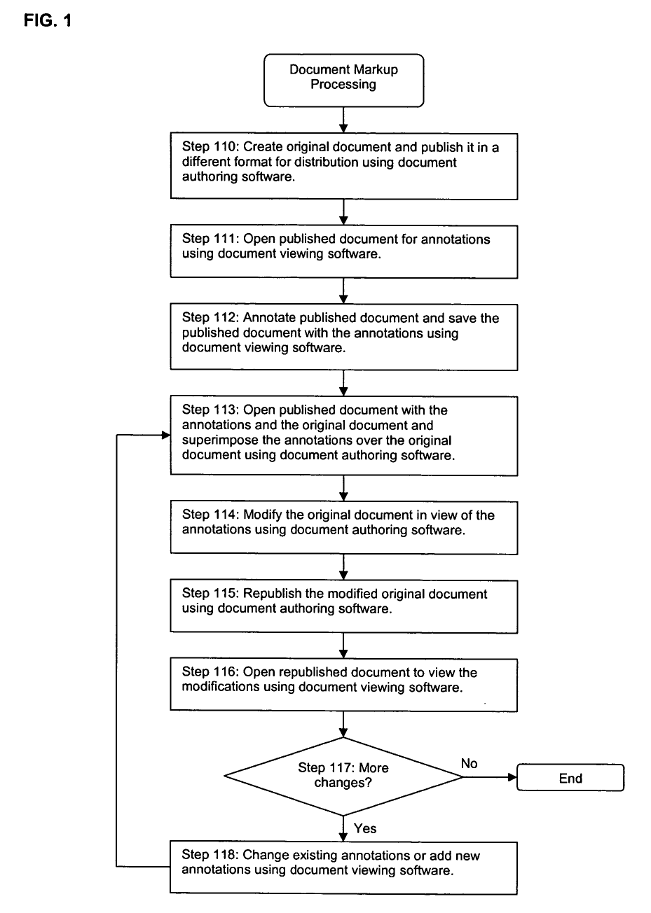

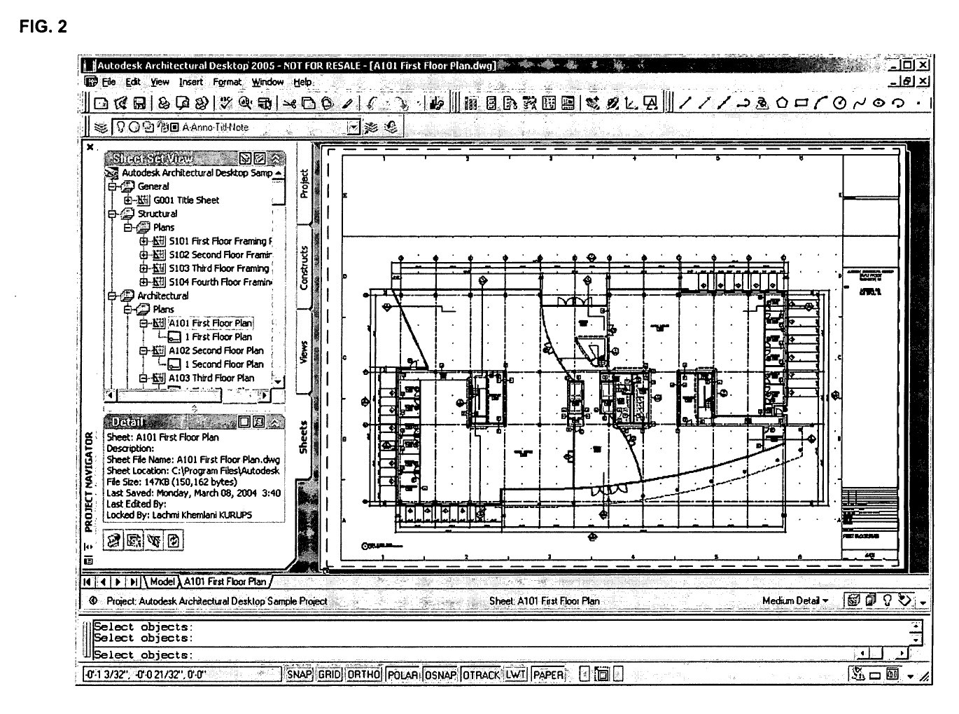

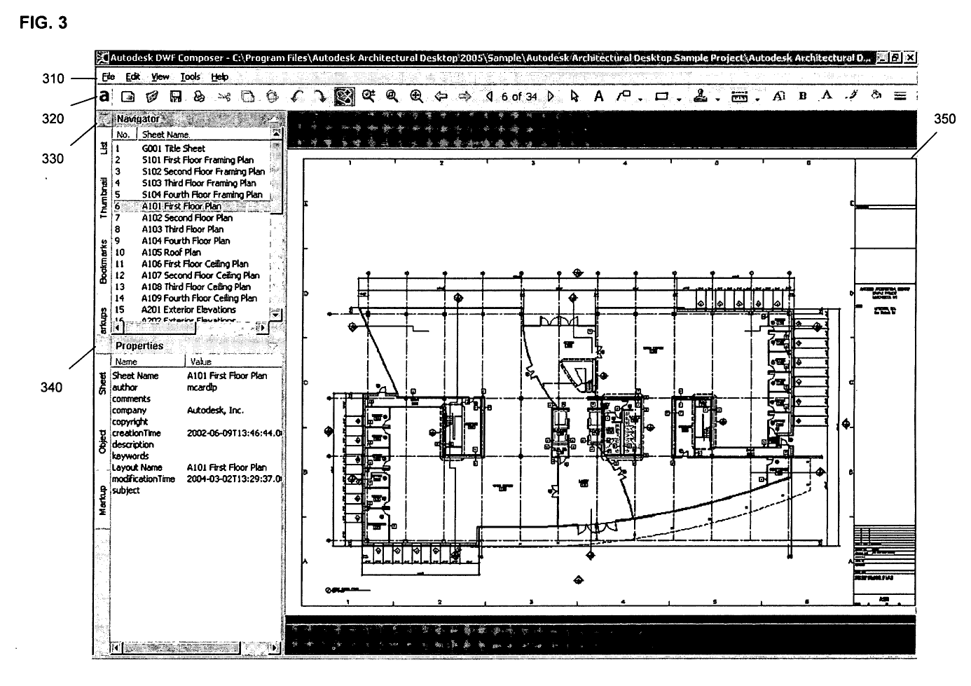

The present invention supports variations on the following workflow example, which is illustrated in FIG. 1. In Step 110, the document creator creates the original drawing in AutoCAD® (see FIG. 2) and publishes it in the DWF format from AutoCAD® for distribution to one or more reviewers. Since the DWF format has multi-sheet capability, a sheet set with multiple drawings can be contained in one DWF file. FIG. 2 shows a sheet set with multiple drawings, that is published as a single DWF file shown in FIG. 3.

In Step 111, the reviewer opens the published DWF file shown in FIG. 3 in DWF Composer. DWF Composer is intended for use by the extended project team for the review of design data, and so it sports a very simple and functional interface, with minimum frills. There are five components: a menu bar 310; a single toolbar 320 below the menu bar, which contains the entire toolset of the application; a Navigator palette 330 which lists all the sheets in the opened sheet set and the markups in a sheet, if any; a Properties palette 340, which provides detailed information on a selected sheet or markup; and finally, a display area 350 on the right, where you can view a sheet and add markups. The palettes, however, can be resized, and a single click on the left bar conveniently toggles between maximizing the display area and making the palettes panel visible. Multiple sessions of the application can be launched simultaneously to work on multiple files if needed.

Once a DWF sheet set is opened in DWF Composer, the List or Thumbnail view of the Navigator palette 330 can be used to browse through the individual sheets. The size of a sheet can be seen in the List view when the Navigator palette 330 is enlarged horizontally. Additional details about a sheet, such as author, company, creation time, and so on, can be seen in the Properties palette 340. Zoom and pan tools are available to examine a sheet more closely. If a sheet was published with the option to include layer information, the layer list can be opened in DWF Composer and the layers can be turned on or off as desired. Similarly, if the original drawing included named views, these can also be accessed in DWF Composer for quick navigation to a selected view.

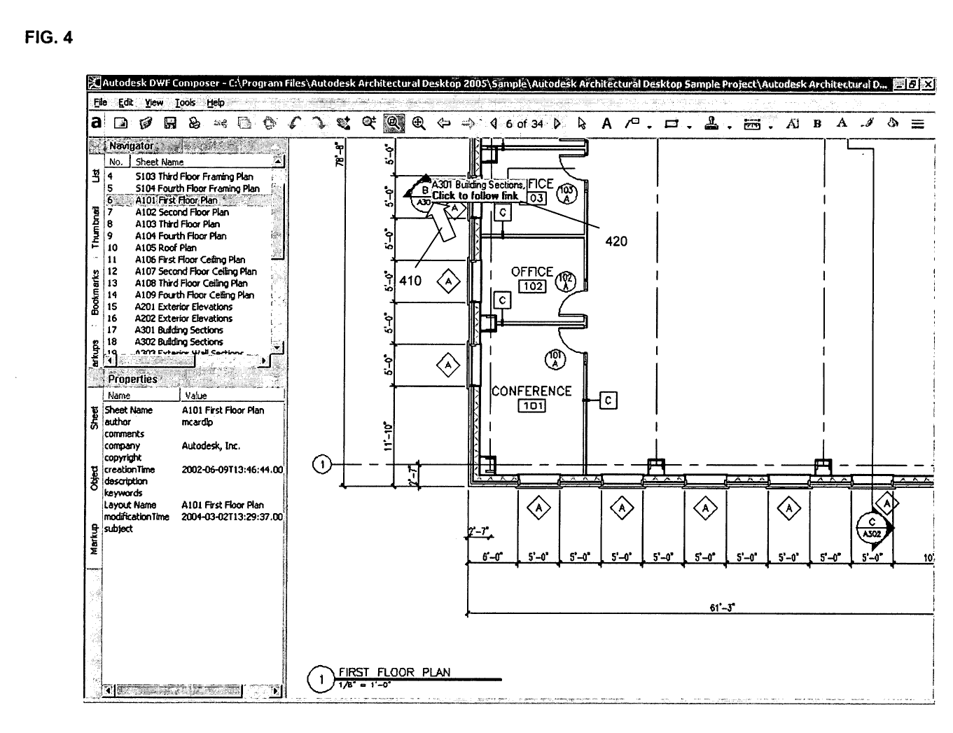

Hyperlinking is another powerful capability that makes it easy to navigate through a large sheet set in DWF Composer. When such a sheet set is published as a DWF file and brought into DWF Composer, the hyperlinks are retained and can be used to quickly navigate through related items. FIG. 4 shows a cursor 410 positioned over such an automatic hyperlink, with a Tooltips display 420 of the sheet to which it links. Clicking on this hyperlink will take you directly to the indicated sheet.

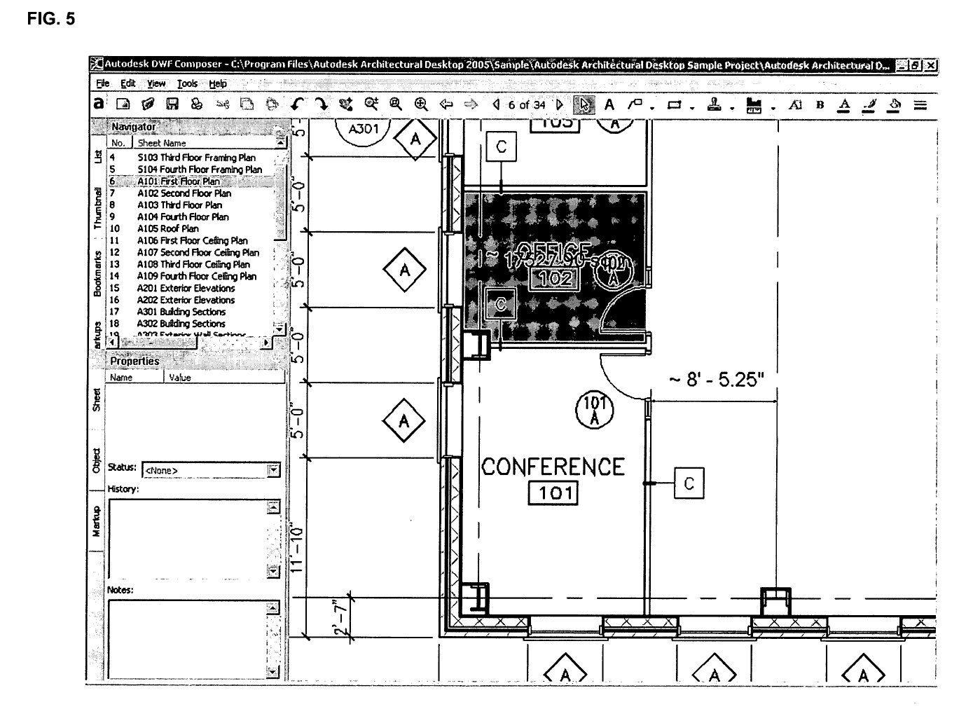

A DWF file published from a design application automatically includes the geometry, scale, and coordinate information of the original design, allowing for accurate measurements without the need to provide a scale or any other calibration information. DWF Composer provides three kinds of measurement tools: Length, Polyline, and Area. FIG. 5 illustrates the use of two of these tools to measure a distance and the area of a space. A Snap to Geometry option is available for more precise snapping.

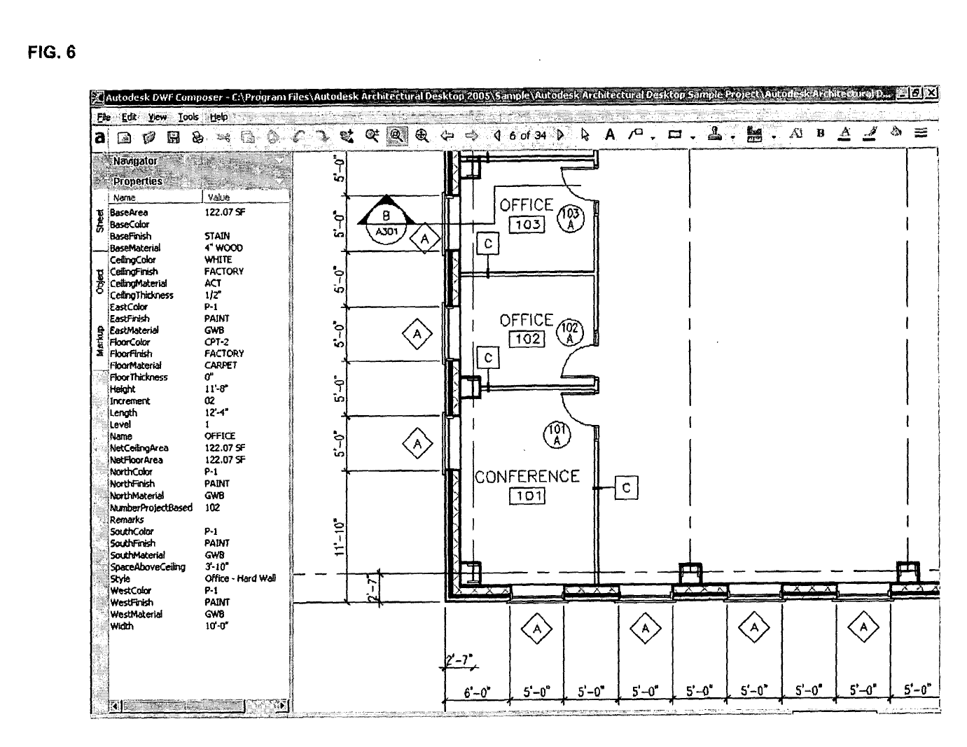

The DWF file shown in FIG. 5 includes the properties of objects in the drawing that were specified in the design. A detailed listing of these properties can be seen in the Properties palette when an object is selected. FIG. 6 shows the properties of the same space whose area was measured in FIG. 5.

Printing sheets can be done from within DWF Composer. The Print dialog box allows the user to specify which sheets to print as well as other settings such as the scale, full page or current view, number of copies, paper size and orientation, and tiling across multiple pages.

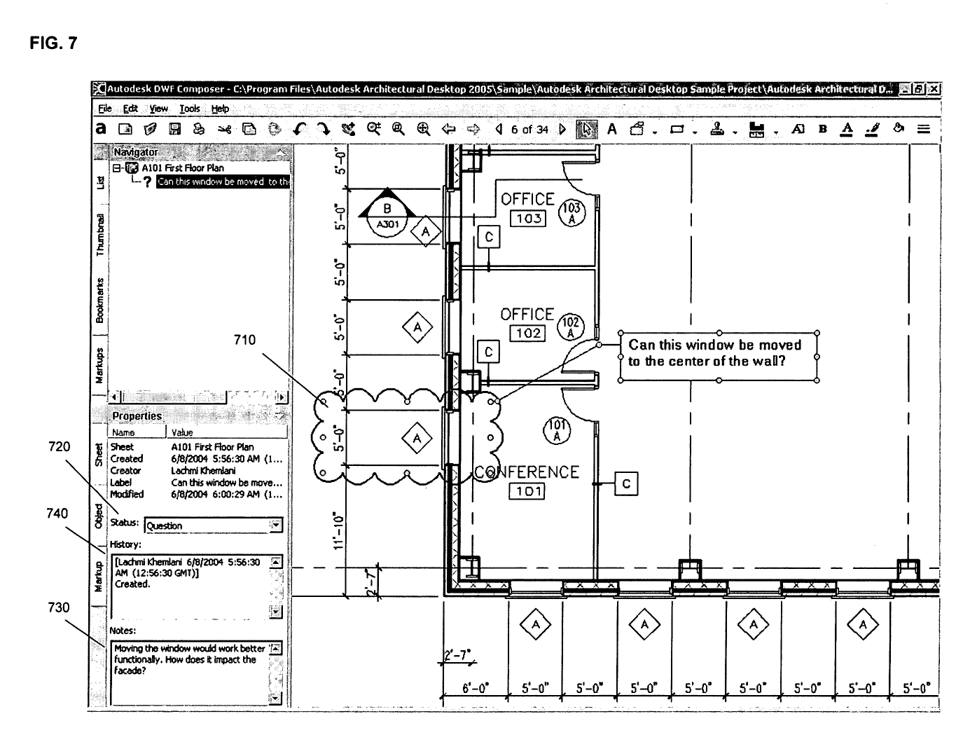

In Step 112, the reviewer makes annotations 710 on the published drawing and saves the published drawing with the annotations. DWF Composer provides the user with the ability to markup DWF files, keep track of markup comments, and exchange the markups directly with AutoCAD®. There are nine different kinds of markup tools; the use of one of these is illustrated in FIG. 7. Markups are automatically recorded in the Navigator palette, and the Properties palette displays information associated with one of the markups automatically recorded in the Navigator palette. More specifically, the Properties palette allows a Status 720 (e.g., “Question” or “For Review”) and additional Notes 730 to be assigned to a markup as shown. The creation time and the name of the author of the markup are automatically recorded in the History section 740.

In addition to dedicated markup tools, DWF Composer also provides various drawing, annotation, and stamp tools that can be added to a sheet. Rounding up the repertoire of the application is the ability to add, delete, and reorder sheets in the sheet set, and the ability to drag and drop of sheets from one instance of DWF Composer to the other. Additional details on the features and functionalities of DWF Composer are provided in the attached Appendix.

Once the DWF file is saved with all the markups by the reviewer and sent back to the document creator, the markup set can be viewed in AutoCAD® by loading the DWF file (Step 113). The annotations are superimposed over the original document, so that the creator can review the changes indicated by the annotations and make changes to the original document. To facilitate the superimposition, AutoCAD® and DWF Composer employ the same 2-D graphics engine.

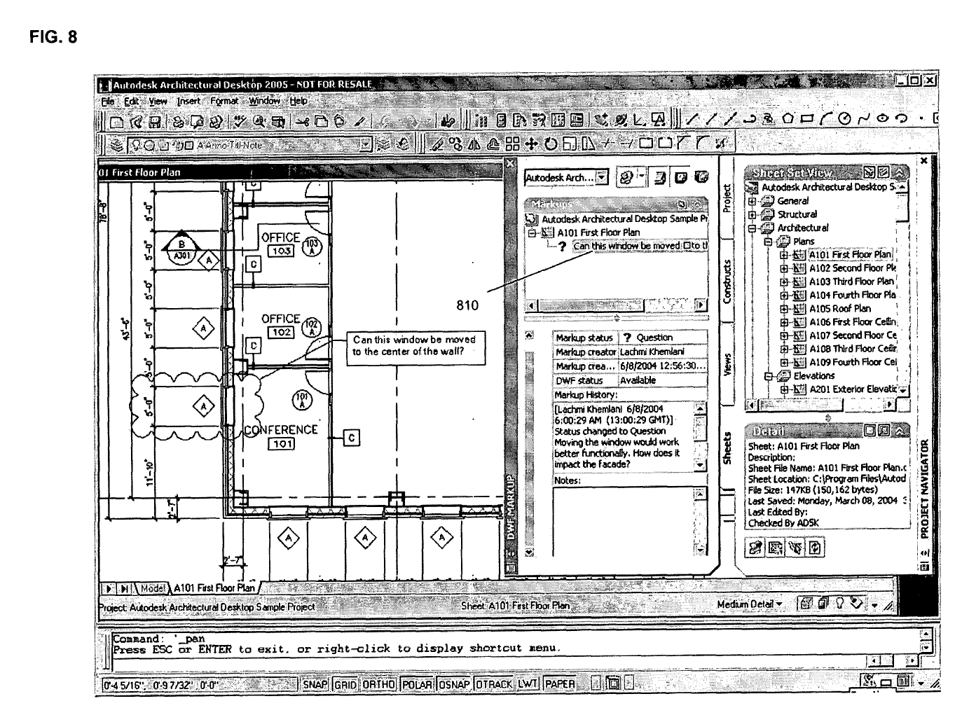

As shown in FIG. 8, selecting a markup from a DWF Markup palette 810 automatically takes the user to the associated drawing sheet and zooms in to the area in need of revision. The designer can now make the appropriate edits. The creator can also view the information about each annotation, including reviewer name, review date, comments and status. The creator can change the status and add comments (Step 114). Comments are tracked so that any participant can view a history of the exchange.

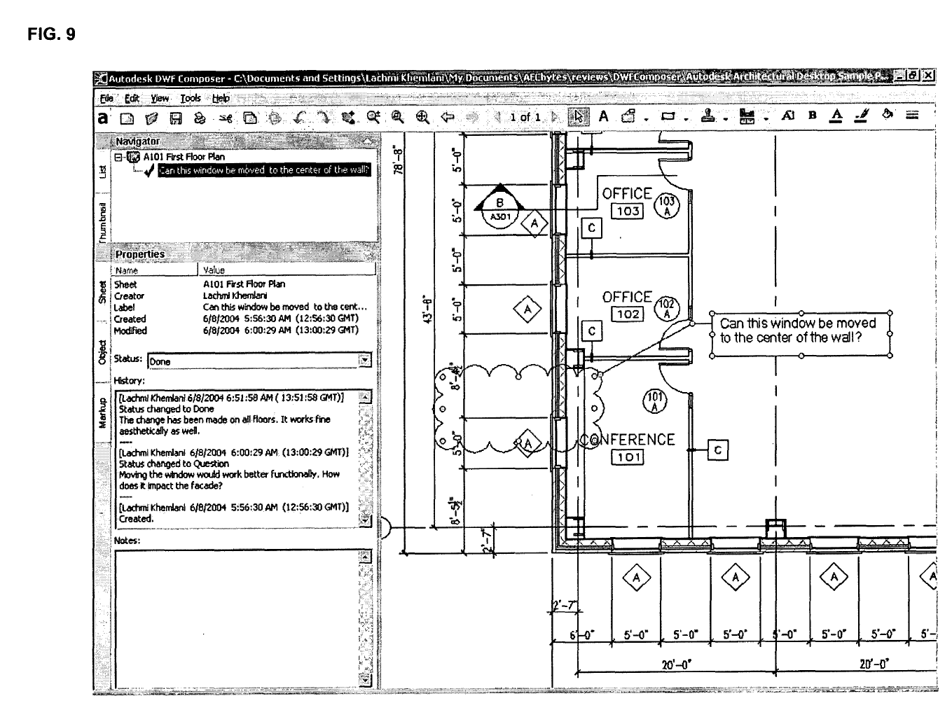

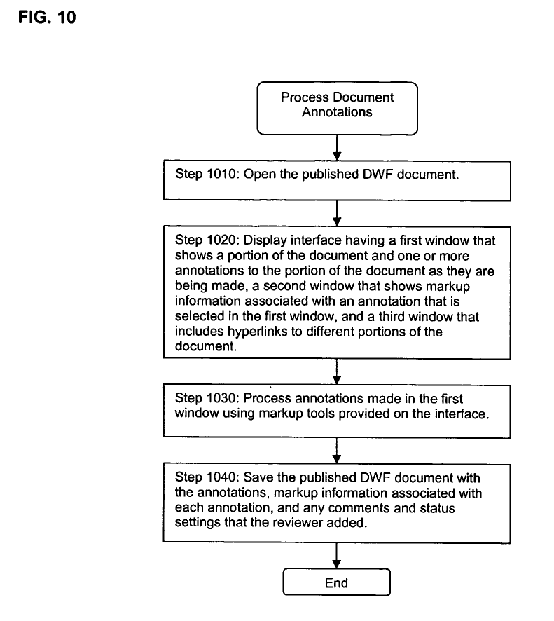

In Step 115, if another cycle of review is required, the document creator can republish the modified drawing using AutoCAD®, along with the original annotations, the additional comments for each annotation, and the modified status. Back in DWF Composer, the reviewer can open the republished file (Step 116) and check on the status of all the markups, as shown in FIG. 9.

If the reviewer determines in Step 117 that additional modifications are necessary, the reviewer can add additional comments, change the existing annotations or add new annotations (Step 118). Markups that have been addressed can now be deleted. The round-trip cycle may then repeat as many times as necessary. When the round-trip cycle is to be repeated, the process returns to Step 113. If it is determined in Step 117 that additional modifications are not necessary, the process ends.

FIG. 10 is a flow diagram of the method of processing annotations to a drawing created using AutoCAD® and published in the DWF format, using DWF Composer. In Step 1010, the published DWF document is opened. In Step 1020, an interface like the one shown in FIG. 3 is displayed. The interface includes a first window that shows a portion of the document and one or more annotations to the portion of the document as they are being made, a second window that shows markup information associated with an annotation that is selected in the first window, and a third window that shows a list of different portions of the document to which navigation is possible. In Step 1030, annotations made in the first window using markup tools provided on the interface are processed. In Step 1040, the published DWF document is saved with the annotations, markup information associated with the annotations, and any comments and status settings that the reviewer added.

While particular embodiments according to the invention have been illustrated and described above, those skilled in the art understand that the invention can take a variety of forms and embodiments within the scope of the appended claims.

What is claimed is:

1. A method of managing markups relating to a document that is created and stored in a first predetermined format and published in a second predetermined format using a software application of a first type, comprising the steps of:
opening the published document using a software application of a second type;
inputting markups to the published document using the software application of the second type;
storing the published document including the markups using the software application of the second type; and
opening the published document including the markups and the document stored in the first predetermined format using the software application of the first type.

2. The method according to claim 1, further comprising the steps of:
modifying the document and storing the document in the first predetermined format using the software application of the first type; and
republishing the document in the second predetermined format using the software application of the first type.

3. The method according to claim 2, further comprising the step of distributing the published document to a plurality of reviewers, wherein the step of inputting markups is carried out by one of the reviewers.

4. The method according to claim 1, wherein the software application of the first type is a document authoring software and the software application of the second type is a document viewing software.

5. The method according to claim 4, wherein the document is a drawing file.

6. The method according to claim 1, wherein the markups include graphic markups that are stored as a series of 2D vectors.

7. The method according to claim 6, wherein the published document is stored to also include certain properties associated with the markups.

8. The method according to claim 7, wherein the document is a drawing file having a plurality of drawing sheets, and wherein the step of inputting markups includes the step of adding a drawing sheet from a different document that has been published in the second predetermined format.

9. A method of processing annotations to a document that has been published in a predetermined format by a document authoring software, using a document viewing software that is different from the document authoring software, comprising the steps of:
opening the document published in the predetermined format;
displaying a first window that shows a portion of the document and one or more markups to the portion of the document as they are being made;
displaying a second window that shows markup information associated with a markup that is selected in the first window; and
storing the document including the markups to the document and their associated markup information in the predetermined format.

10. The method according to claim 9, further comprising the step of displaying a third window that includes a list of different portions of the document, wherein a selection of a list item in the third window causes a display of the corresponding portion of the document in the first window.

11. The method according to claim 10, further comprising the steps of:
displaying a tool bar including graphic elements; and
marking up the portion of the document shown in the first window using a graphic element selected from the tool bar.

12. The method according to claim 11, further comprising the step of displaying of an input field in the second window into which notes about a markup may be entered.

13. The method according to claim 9, wherein the document is a drawing file including one ore more drawing sheets and the method further comprises the step of adding a drawing sheet from a different document that has been published in the predetermined format.

14. The method according to claim 9, further comprising the steps of automatically generating time information of a markup based on when the markup was made, and storing the time information as part of the markup information associated with the markup.

15. A computer readable medium comprising program instructions of a document viewing software that is able to view a document that is published in a predetermined format by a document authoring software that is different from the document viewing software, the program instructions of the document viewing software further comprising program instructions for carrying out the steps of:
opening the document published in the predetermined format;
displaying a first window that shows a portion of the document and one or more markups to the portion of the document as they are being made;
displaying a second window that shows markup information associated with a markup that is selected in the first window; and
storing the document including the markups to the document and their associated markup information in the predetermined format.

16. The computer readable medium according to claim 15, further comprising program instructions for carrying out the step of displaying a third window that includes a list of different portions of the document, wherein a selection of a list item in the third window causes a display of the corresponding portion of the document in the first window.

17. The computer readable medium according to claim 16, further comprising program instructions for carrying out the step of:
displaying a tool bar including graphic elements; and
marking up the portion of the document shown in the first window using a graphic element selected from the tool bar.

18. The computer readable medium according to claim 17, further comprising program instructions for carrying out the step of displaying of an input field in the second window into which notes about a markup may be entered.

19. The computer readable medium according to claim 15, wherein the document is a drawing file including one ore more drawing sheets and the program instructions of the document viewing software further comprises program instructions for carrying out the step of adding a drawing sheet from a different document that has been published in the predetermined format.

20. The computer readable medium according to claim 15, further comprising program instructions for carrying out the steps of automatically generating time information of a markup based on when the markup was made, and storing the time information as part of the markup information associated with the markup.
